(19) United States
(12) Patent Application Publication
(10) Pub. No.: US 2022/0374250 A1
(43) Pub. Date: Nov. 24, 2022

(54) INTEGRATION SYSTEM AND INTEGRATION METHOD

(71) Applicant: Hitachi, Ltd., Tokyo (JP)

(72) Inventors: Takashi TAKAGI, Tokyo (JP); Hayato AKIYAMA, Tokyo (JP); Akira MATSUI, Tokyo (JP)

(21) Appl. No.: 17/688,507

(22) Filed: Mar. 7, 2022

(30) Foreign Application Priority Data
May 24, 2021 (JP) 2021-087165

(51) Int. Cl. G06F 9/451; G06F 11/30

(52) U.S. Cl. CPC G06F 9/451; G06F 11/3055; G06F 11/3006

(57) ABSTRACT

Provided is an integration system capable of integrating a plurality of GUI products without having to modify each of the plurality of GUI products. The integration system comprises an acquisition unit which acquires a screen capture of each of the plurality of GUI products according to condition information indicating a condition of acquiring the screen capture of the GUI product for each of the plurality of GUI products, a storage unit which stores the screen captures acquired by the acquisition unit, a generation unit which generates an integrated screen on which are arranged the screen captures stored in the storage unit according to the screen configuration information indicating a screen configuration of the integrated screen regarding the plurality of GUI products, and an output unit which outputs the integrated screen generated by the generation unit.

### TECHNICAL FIELD

The present invention generally relates to a technology of integrating a plurality of GUI products.

### BACKGROUND ART

Conventionally, GUI products which monitor items to be monitored such as hardware, OS (Operating System), middleware and applications of a system are being used to assess the status of the system. When an item to be monitored in a system is to be increased, there are cases where a GUI product is added. In a case of using a plurality of GUI products, a system which integrates a plurality of GUI products (hereinafter referred to as the “integration system”) is required for collectively assessing information of the plurality of GUI products.

With respect to this point, disclosed is a split screen display system capable of displaying a screen of a GUI product in each area that the screen has been split (see PTL 1).

### CITATION LIST

### Patent Literature

[PTL 1] Japanese Unexamined Patent Application Publication No. 2004-318566

### SUMMARY OF THE INVENTION

### Problems to be Solved by the Invention

With the technology described in PTL 1, while there is no need to give consideration to all display modes that are available to the system in creating a GUI product, since consideration needs to be given to the optimal display mode, each GUI product needs to be modified in order to integrate a plurality of GUI products.

Moreover, in recent years, for the purpose of providing and using software, which is being provided as a GUI product, as a service via the internet, a WEB system configured from a WEB application server and GUI products is being developed. When building a WEB system, an interface other than a GUI, such as RESTAPI, is prepared for the GUI products, and the WEB application server undergoes development using an API for each of the GUI products. In the foregoing case, when the GUI product is not equipped with an interface other than a GUI, it is necessary to modify the GUI product in addition to developing the WEB application server, and the number of manhours for development will increase.

The present invention was devised in consideration of the foregoing points, and an object of this invention is to propose an integration system capable of integrating a plurality of GUI products without having to modify each of the plurality of GUI products.

### Means to Solve the Problems

In order to achieve the foregoing object, the present invention provides an integration system to which are connected a plurality of GUI (Graphical User Interface) products as application programs comprising a GUI, comprising: an acquisition unit which acquires a screen capture of each of the plurality of GUI products according to condition information indicating a condition of acquiring the screen capture of the GUI product for each of the plurality of GUI products; a storage unit which stores the screen captures acquired by the acquisition unit; a generation unit which generates an integrated screen on which are arranged the screen captures stored in the storage unit according to the screen configuration information indicating a screen configuration of the integrated screen regarding the plurality of GUI products; and an output unit which outputs the integrated screen generated by the generation unit.

In the configuration described above, screen captures of the respective GUI products are acquired and output as an integrated screen. With the foregoing configuration, since a screen capture that can be acquired with the GUI equipped in the GUI product is used for the generation of the integrated screen, a plurality of GUI products can be integrated irrespective of whether the GUI product is equipped with an interface other than a GUI. For example, even if the GUI product to be integrated is does not have an interface other than a GUI product, there is no need to modify the GUI product, and the number of manhours for development required for such modification can be reduced.

### Advantageous Effects of the Invention

According to the present invention, it is possible to integrate a plurality of GUI products.

### BRIEF DESCRIPTION OF DRAWINGS

FIG. 1 is a diagram showing an example of the configuration of the integration system according to the first embodiment.

FIG. 2 is a diagram showing an example of the hardware of the GUI integration server according to the first embodiment.

FIG. 3 is a diagram showing an example of the acquisition condition information according to the first embodiment.

FIG. 4 is a diagram showing an example of the capture management information according to the first embodiment.

FIG. 5 is a diagram showing an example of the authority information according to the first embodiment.

FIG. 6 is a diagram showing an example of the screen configuration information according to the first embodiment.

FIG. 7 is a diagram showing an example of the cutout condition information according to the first embodiment.

FIG. 8 is a diagram showing an example of the processing related to the integrated screen according to the first embodiment.

FIG. 9 is a diagram showing an example of the acquisition processing according to the first embodiment.

FIG. 10 is a diagram showing an example of the sequence according to the first embodiment.

FIG. 11 is a diagram showing an example of the integrated screen generation processing according to the first embodiment.

FIG. 12 is a diagram showing an example of the integrated screen according to the first embodiment.

FIG. 13 is a diagram showing an example of the sequence according to the second embodiment.

FIG. 14 is a diagram showing an example of the integrated screen according to the second embodiment.

FIG. 15 is a diagram showing an example of the monitoring information according to the third embodiment.

FIG. 16 is a diagram showing an example of the sequence according to the third embodiment.

FIG. 17 is a diagram showing an example of the integrated screen according to the third embodiment.

### DESCRIPTION OF EMBODIMENTS

### (I) First Embodiment

An embodiment of the present invention is now explained in detail. Nevertheless, the present invention is not limited to the following embodiments.

This embodiment explains an integration system for integrating a plurality of GUI products. The integration system stores condition information indicating the condition of acquiring a screen capture of a GUI product for each of a plurality of GUI products. The integration system acquires a screen capture of each of the plurality of GUI products based on the condition information, generates an integrated screen in which the acquired screen captures are arranged according to the screen configuration information indicating a pre-defined screen configuration, and displays the generated integrated screen on a display device. According to the integrated screen, the screen captures of a plurality of GUI products can be collectively displayed.

Here, there may be cases where the screens of the GUI products browsed by users using the integration system are different. With the conventional technology, while the development is performed by the WEB application server, since such development differs for each GUI product, it is necessary to develop the integrated screen according to the user, and the number of manhours for development will increase. With respect to this point, the integration system of this embodiment manages the screen capture by associating the user information with the screen capture, and stores the screen configuration information for each piece of user information. With the integration system of this embodiment, the screen captures of the GUI products to be arranged on the integrated screen are switched according to the user information. Consequently, the integrated screen can be switched according to the user without having to modify the GUI products.

Moreover, there may be cases where the screens of the GUI products browsed by users having different authorities are different. With the conventional technology, while the development is performed by the WEB application server, since such development differs for each GUI product, it is necessary to develop the integrated screen according to the authority, and the number of manhours for development will increase. With respect to this point, the integration system of this embodiment manages the screen capture by associating the authority information with the screen capture, and stores the screen configuration information for each piece of authority information. With the integration system of this embodiment, the screen captures of the GUI products to be arranged on the integrated screen are switched according to the user's authority information. Consequently, the integrated screen can be switched according to the user's authority without having to modify the GUI products.

Moreover, there may be cases where the screens to be browsed by users are different according to the status of the system including the items to be monitored by the GUI products. When switching the integrated screen according to the status of the system, with the conventional technology, the user needed to operate each GUI product and switch the screen to be browsed. With respect to this point, the integration system of this embodiment stores the screen configuration information for each piece of status information of the system. Moreover, the integration system of this embodiment manages the status information of the system. With the integration system of this embodiment, the screen captures of the GUI products to be arranged on the integrated screen are switched according to the status information of the system. Consequently, the integrated screen can be switched according to the status of the system without having to modify the GUI products.

Moreover, with a conventional WEB system, when a GUI product does not have an interface such as an API or lacks functions, that GUI product cannot be integrated. With respect to this point, since the integration system of this embodiment uses screen captures, a GUI product can be integrated even if the GUI product does not have an interface such as an API or lacks functions.

Moreover, with a conventional WEB system, since the development to be performed by the WEB application server differs for each GUI product, the number of manhours for development will increase as the number of GUI products increases. With respect to this point, since the integration system of this embodiment can be developed irrespective of the specification of the GUI products, the number of manhours for development can be reduced in comparison to a conventional WEB system.

Moreover, with a conventional WEB system, when there is a specification change to the API of the GUI product, additional development for conforming to the specification change is required. With respect to this point, even when there is a specification change to the API of the GUI product, the integration system of this embodiment will not be required to undergo development for conforming to the specification change.

An embodiment of the present invention is now explained with reference to the appended drawings. Embodiments are exemplifications for explaining the present invention, and certain descriptions are omitted or simplified as needed for clarifying the explanation of the present invention. The present invention can also be worked in other various modes. Unless specifically limited herein, each constituent element may be singular or plural.

Note that, in the following explanation, the same reference numeral is assigned to the same element in the drawings, and any redundant explanation will be omitted. Moreover, when the same types of elements are explained without being differentiated, the common part (part excluding the branch number) of the reference code including the branch number will be used, and when the same types of elements are explained by being differentiated, the reference code including the branch number may be used. For example, when the GUI products are explained without being differentiated, they will be indicated as “GUI product 102”, and when the individual GUI products are explained by being differentiated, they may be indicated as “GUI product 102-1”, “GUI product 102-2” and so on.

Expressions such as “first”, “second”, “third” and the like in the present specification and the drawings are affixed for identifying the constituent elements, and are not necessarily limited to quantity or order. Moreover, the numbers used for identifying the constituent elements are used for each context, and a number used in one context may not necessarily refer to the same configuration in another context. Moreover, a constituent element identified with a certain number is not precluded from concurrently serving the function of a constituent element identified with another number.

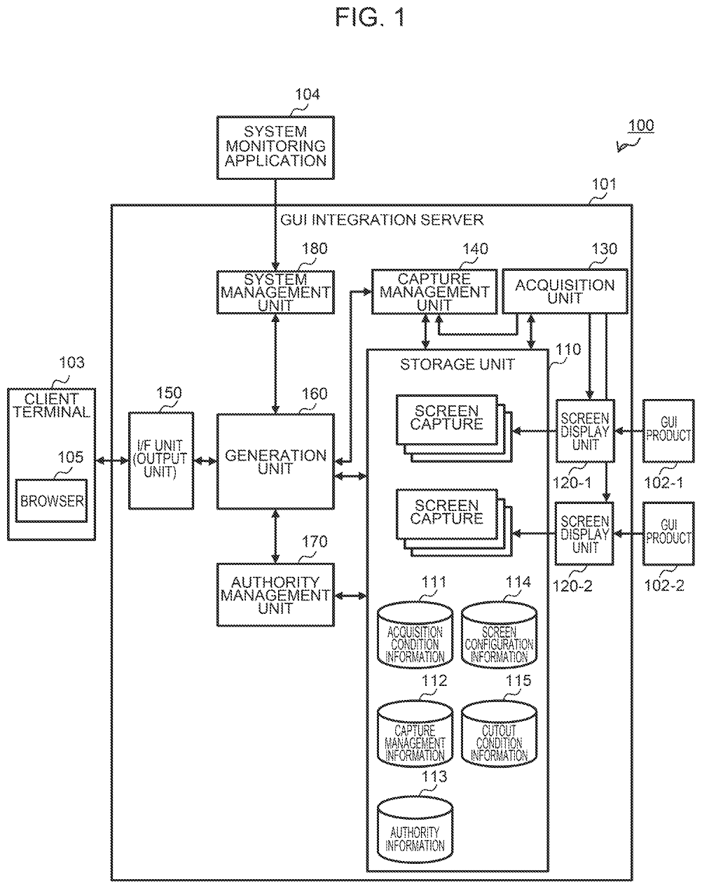

In FIG. 1, reference numeral 100 depicts the overall integration system according to the first embodiment.

FIG. 1 is a diagram showing an example of the configuration of the integration system 100. The integration system 100 is configured by including a GUI integration server 101.

The GUI integration server 101 is communicably connected to a plurality of GUI products 102, one or more client terminals 103, and a system monitoring application 104.

The GUI product 102 is an application program installed in a machine such as a physical machine or a virtual machine, and monitors one or more items to be monitored of a specified system. The items to be monitored are hardware, OS, middleware, application programs and the like installed in the specified system. Moreover, the GUI product 102 comprises a GUI, and outputs visual information including the items to be monitored (hereinafter referred to as the “screen”). The GUI product 102 sends, at a predetermined timing, the screen to be monitored to the GUI integration server 101. Note that “predetermined timing” is the timing that satisfies the acquisition condition described later, and may be constantly, regularly (periodically), at a predetermined time, timing designated by the user, or any other timing.

For example, a GUI product 102-1 monitors items to be monitored of a first system, and a GUI product 102-2 monitors items to be monitored of a second system. The first system and the second system may be the same system, or may be different systems. In the following explanation, the respective specified systems installed with items to be monitored by each GUI product 102 are hereinafter collectively referred to as the “system to be monitored”. For example, in cases where the GUI product 102-1 and the GUI product 102-2 are connected to the GUI integration server 101 and the GUI product 102-1 is monitoring the items to be monitored of the first system and the GUI product 102-2 is monitoring the items to be monitored of the second system, the system to be monitored will be the first system and the second system. Note that the GUI product 102-1 and the GUI product 102-2 may be installed in the same machine or may be installed in different machines.

The client terminal 103 is a laptop computer, a tablet terminal, a smartphone or the like. The client terminal 103 comprises, for example, a browser 105 capable of displaying an integrated screen in which the screens of a plurality of GUI products 102 are integrated by the GUI integration server 101.

The system monitoring application 104 is an application program installed in a machine such as a physical machine or a virtual machine. The system monitoring application 104 monitors the system to be monitored and acquires, for example, status information indicating a status of the system to be monitored. Note that the system monitoring application 104 may be included in the GUI integration server 101, or may be included in the GUI product 102.

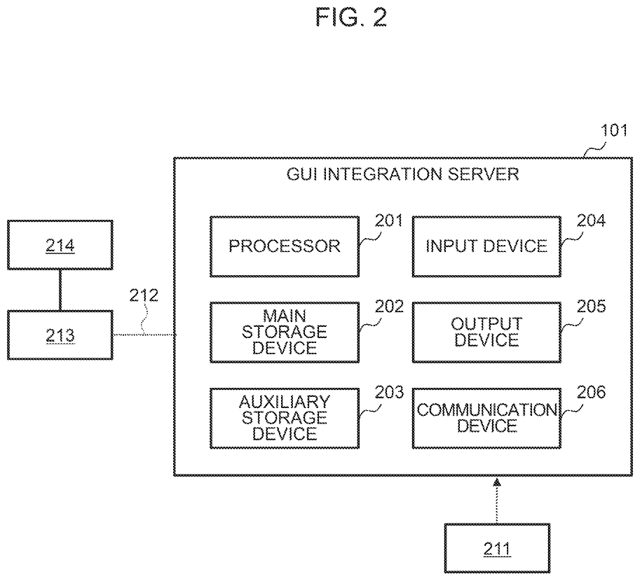

In the integration system 100, the GUI integration server 101 displays a screen (screen display) output from the GUI product 102, acquires the overall screen display as a screen capture, and uses the acquired screen captures to generate an integrated screen of a plurality of GUI products 102. The GUI integration server 101 is a general-purpose computer, a host computer or the like. Note that the configuration of the hardware of the GUI integration server 101 will be explained later with reference to FIG. 2.

More specifically, the GUI integration server 101 comprises a storage unit 110, a screen display unit 120, an acquisition unit 130, a capture management unit 140, an I/F unit 150, a generation unit 160, an authority management unit 170, and a system management unit 180.

The storage unit 110 stores, for example, the screen captures to be used in the integrated screen. Moreover, for example, the storage unit 110 stores, as information related to the generation of the integrated screen, acquisition condition information 111, capture management information 112, authority information 113, screen configuration information 114, cutout condition information 115 and the like.

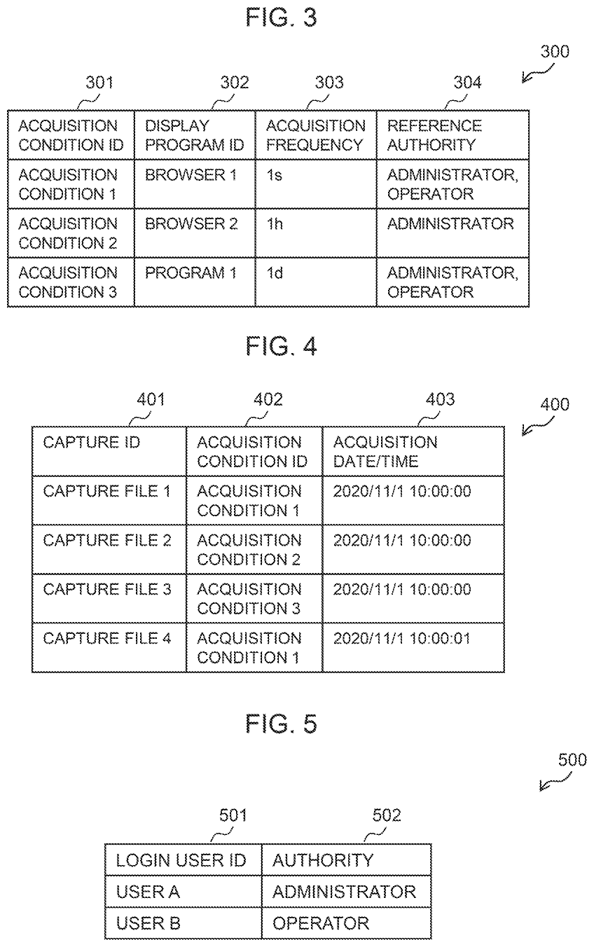

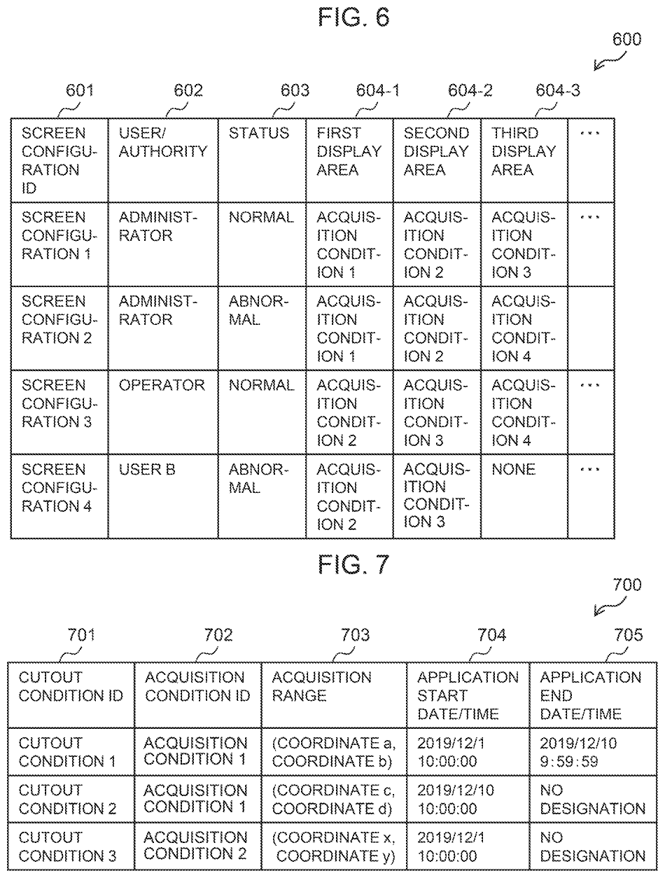

The acquisition condition information 111 is information indicating the acquisition condition of the screen capture, and the details thereof will be explained later with reference to FIG. 3. The capture management information 112 is information that is used for managing the screen capture, and the details thereof will be explained later with reference to FIG. 4. The authority information 113 is information that is used for managing the user's authority, and the details thereof will be explained later with reference to FIG. 5. The screen configuration information 114 is information indicating the screen configuration of the integrated screen, and the details thereof will be explained later with reference to FIG. 6. The cutout condition information 115 is information indicating the cutout condition for cutting out, from the screen capture, the screen of an area to be used in the integrated screen, and the details thereof will be explained later with reference to FIG. 7.

The screen display unit 120 displays a screen (screen display) output from the GUI product 102. The screen display unit 120 is, for example, an application program capable of displaying a screen (hereinafter referred to as the “display program”).

The acquisition unit 130 acquires, as the screen capture, the screen display by the screen display unit 120 according to the condition of the acquisition condition information 111.

The capture management unit 140 manages the screen capture based on the capture management information 112. For example, when the capture management unit 140 receives a request for acquiring the screen capture to be used in the integrated screen (hereinafter referred to as the “acquisition request”) from the generation unit 160, the capture management unit 140 identifies the screen capture for which an acquisition request has been made based on the capture management information 112, reads the identified screen capture via the storage unit 110, and sends the identified screen capture to the generation unit 160. Note that the capture management unit 140 may also instruct the storage unit 110 to send the identified screen capture to the generation unit 160.

The I/F unit 150 receives a request for browsing the integrated screen (hereinafter referred to as the “browsing request”) from the client terminal 103, or sends, to the client terminal 103, the integrated screen corresponding to the browsing request generated by the generation unit 160. The browsing request includes user information capable of identifying the user. The user information is the user's user name, user ID or the like.

The generation unit 160 generates an integrated screen corresponding to the browsing request based on the browsing request of the integrated screen. For example, the generation unit 160 sends the user's user information to the authority management unit 170 in order to confirm the authority of the user who made the browsing request. Moreover, for example, the generation unit 160 sends status confirmation information for making an inquiry regarding the status to the system management unit 180 in order to confirm the current status of the system to be monitored that is being monitored by the system monitoring application 104. Moreover, for example, the generation unit 160 sends an acquisition request to the capture management unit 140 for acquiring the screen capture to be used in the integrated screen corresponding to the browsing request. Moreover, for example, the generation unit 160 cuts out, based on the cutout condition information 115, the screen of an area to be used in the integrated screen from the screen capture obtained pursuant to the acquisition request, and generates an integrated screen on which are arranged the screens cut out based on the screen configuration information 114 (hereinafter referred to as the “cutout screen(s)”).

When the authority management unit 170 receives user information from the generation unit 160, the authority management unit 170 acquires, from the authority information 113, authority information indicating the authority of the user of the user information, and sends the acquired authority information to the generation unit 160.

When the system management unit 180 acquires status confirmation information from the generation unit 160, the system management unit 180 acquires, from the system monitoring application 104, status information indicating the current status of the system to be monitored, and sends the acquired status information to the generation unit 160.

FIG. 2 is a diagram showing an example of the hardware of the GUI integration server 101.

The GUI integration server 101 comprises a processor 201, a main storage device 202, an auxiliary storage device 203, an input device 204, an output device 205, and a communication device 206.

The processor 201 is a device that performs arithmetic processing. The processor 201 is, for example, a CPU (Central Processing Unit), an MPU (Micro Processing Unit), a GPU (Graphics Processing Unit), an AI (Artificial Intelligence) chip or the like.

The main storage device 202 is a device which stores programs, data and the like. The main storage device 202 is, for example, a ROM (Read Only Memory), a RAM (Random Access Memory) or the like. The ROM is an SRAM (Static Random Access Memory), an NVRAM (Non Volatile RAM), a mask ROM (Mask Read Only Memory), a PROM (Programmable ROM) or the like. The RAM is a DRAM (Dynamic Random Access Memory) or the like.

The auxiliary storage device 203 is a hard disk drive, a flash memory, an SSD (Solid State Drive), an optical storage device or the like. The optical storage device is a CD (Compact Disc), a DVD (Digital Versatile Disc) or the like. The programs, data and the like stored in the auxiliary storage device 203 are read into the main storage device 202 as needed.

The input device 204 is a user interface which receives information from the user. The input device 204 is, for example, a keyboard, a mouse, a card reader, a touch panel or the like.

The output device 205 is a user interface which outputs (display output, sound output, print output or the like) various types of information. The output device 205 is, for example, a display which visualizes various types of information, a sound output device (speaker), a printing device or the like.

The communication device 206 is a communication interface which communicates with other devices via a communication medium. The communication device 206 is, for example, an NIC (Network Interface Card), a wireless communication module, a USB (Universal Serial Interface) module, a serial communication module or the like. The configuration of the communication medium is not necessarily limited. The communication medium is, for example, a USB (Universal Serial Bus), a communication medium compliant with various communication standards such as RS-232C, a LAN (Local Area Network), a WAN (Wide Area Network), internet, a dedicated line or the like. Note that the communication device 206 can also function as an input device which receives information from other devices that are communicably connected. Moreover, the communication device 206 can also function as an output device which sends information to other devices that are communicably connected.

Moreover, the programs related to the control of the GUI integration server 101 described above may also be provided through data signals of a storage medium such as a CD-ROM 211, the internet or the like. The GUI integration server 101 can receive programs via the CD-ROM 211. Moreover, the GUI integration server 101 may include a connection function for connecting to a communication line 212. A computer 213 is a service computer capable of providing the programs, and stores the programs in a storage medium such as a storage apparatus 214 or the like. The communication line 212 is the internet, a communication line of PC communication or the like, or a dedicated communication line or the like. The computer 213 may read the programs from the storage apparatus 214, and send the programs to the GUI integration server 101 via the communication line 212. In other words, the computer 213 may send the programs as data signals to the communication line 212 via carrier waves. As described above, the programs can be provided as computer-readable computer program products in various forms such as storage mediums, data signals (carrier waves) and the like.

The functions (storage unit 110, screen display unit 120, acquisition unit 130, capture management unit 140, I/F unit 150, generation unit 160, authority management unit 170, system management unit 180 and the like) of the GUI integration server 101 may be realized, for example, by the processor 201 reading the programs stored in the auxiliary storage device 203 into the main storage device 202 and executing the programs (software), or realized with hardware such as a dedicated circuit or the like, or realized based on a combination of software and hardware. Note that one function of the GUI integration server 101 may be divided into a plurality of functions, or a plurality of functions may be consolidated into one function. Moreover, a part of the functions of the GUI integration server 101 may be provided as a separate function, or included in another function. Moreover, a part of the functions of the GUI integration server 101 may be realized with another computer capable of communicating with the GUI integration server 101.

Note that, while the GUI integration server 101 was explained as a physical machine in this embodiment, the GUI integration server 101 may also be a virtual machine.

FIG. 3 is a diagram showing an example (acquisition condition table 300) of the acquisition condition information 111.

The acquisition condition table 300 stores a record including values of a plurality of items indicating the acquisition condition information 111. More specifically, the acquisition condition table 300 stores a record associated with information such as an acquisition condition ID 301, a display program ID 302, an acquisition frequency 303, and a browsing authority 304.

The acquisition condition ID 301 is an item indicating the information for identifying the acquisition condition of acquiring a screen capture. The acquisition condition is a condition of the acquisition unit 130 acquiring a screen capture, such as a display program of the target from which the acquisition unit 130 is to acquire a screen capture or a frequency that the acquisition unit 130 is to acquire a screen capture, and is defined to match the characteristics of the GUI product 102. The display program ID 302 is an item indicating the information for identifying the display program (screen display unit 120) to display a screen of the screen capture output from the GUI product 102. The acquisition frequency 303 is an item indicating the information of the timing of acquiring the screen capture (hereinafter referred to as the “acquisition frequency”). The browsing authority 304 is an item indicating the information of the authority of users allowed to browse the screen capture. Note that, when generating an integrated screen, if it is determined that the user has a browsing authority based on the browsing authority 304, the screen capture acquired based on the corresponding acquisition condition may be used.

FIG. 4 is a diagram showing an example (capture management table 400) of the capture management information 112.

The capture management table 400 stores a record including values of a plurality of items indicating the capture management information 112. More specifically, the capture management table 400 stores a record associated information such as a capture ID 401, an acquisition condition ID 402, and an acquisition date/time 403.

The capture ID 401 is an item indicating the information for identifying the screen capture stored in the storage unit 110 (screen capture acquired by the acquisition unit 130). The acquisition condition ID 402 is an item indicating the information for identifying the acquisition condition used for acquiring the screen capture. The acquisition date/time 403 is an item indicating the information of the date/time that the screen capture was acquired.

FIG. 5 is a diagram showing an example (authority table 500) of the authority information 113.

The authority table 500 stores a record including values of a plurality of items indicating the authority information 113. More specifically, the authority table 500 stores a record associated with information such as a login user ID 501, and an authority 502.

The login user ID 501 is an item indicating the information for identifying the user (login user) using the integration system 100. The authority 502 is an item indicating the authority information of the authority granted to the user.

FIG. 6 is a diagram showing an example (screen configuration table 600) of the screen configuration information 114.

The screen configuration table 600 is a table for managing the screen configuration of the integrated screen according to the user and/or the authority, and the status. The screen configuration table 600 stores a record including values of a plurality of items indicating the screen configuration information 114. More specifically, the screen configuration table 600 stores a record associated with information such as a screen configuration ID 601, a user/authority 602, a status 603, and a plurality of display areas 604.

The screen configuration ID 601 is an item indicating the information for identifying the screen configuration of the integrated screen. The user/authority 602 is an item indicating the user information or the authority information of the user and/or the user's authority to be used in the integrated screen. The status 603 is an item indicating the status information of the status in which the screen configuration is to be used. The display area 604 is an item indicating the identification information for identifying the screen capture to be displayed on the display area of the screen configuration. Note that, while an acquisition condition ID is used as an example in explaining the identification information, other information such as a cutout condition ID may also be used.

FIG. 7 is a diagram showing an example (cutout condition table 700) of the cutout condition information 115.

The cutout condition table 700 stores a record including values of a plurality of items indicating the cutout condition information 115. More specifically, the cutout condition table 700 stores a record associated with information such as a cutout condition ID 701, an acquisition condition ID 702, an acquisition range 703, an application start date/time 704, and an application end date/time 705.

The cutout condition ID 701 is an item indicating the information for identifying the cutout condition of the screen capture. The cutout condition is a condition of cutting a screen of a predetermined area to be used in the integrated screen from the screen capture acquired based on each acquisition condition. The acquisition condition ID 702 is an item indicating the information for identifying the acquisition condition in which the screen capture is to be acquired. The acquisition range 703 is an item indicating the information of the area to be cut out (acquisition range) in the screen capture. The application start date/time 704 is an item indicating the information of the date/time that the application of the cutout condition is to be started. The application end date/time 705 is an item indicating the information of the date/time that the application of the cutout condition is to be ended.

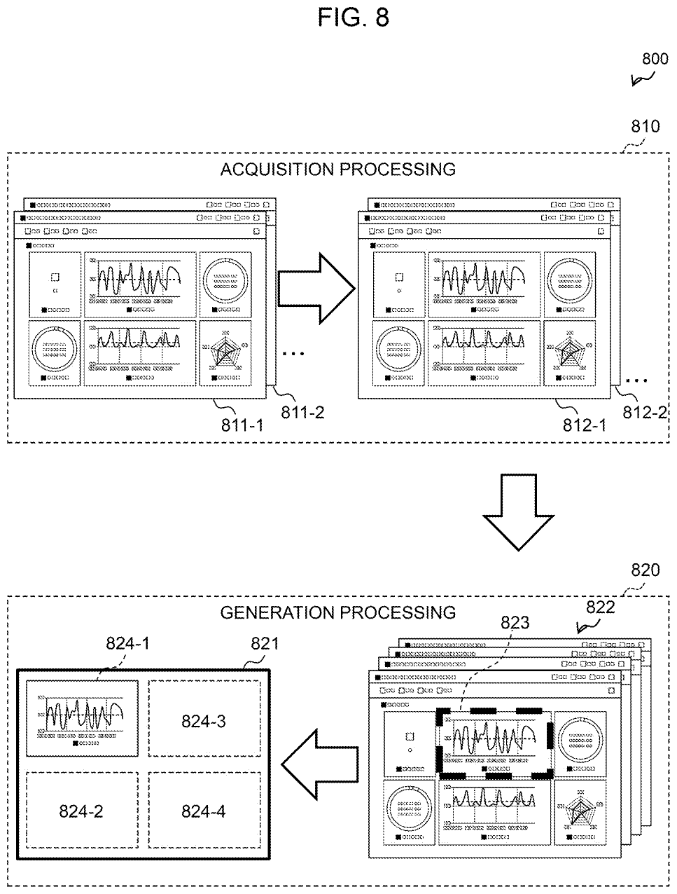

FIG. 8 is a diagram showing an example (integration processing 800) of the processing for providing the integrated screen in the integration system 100. The integration processing 800 is configured by including acquisition processing 810 and generation processing 820.

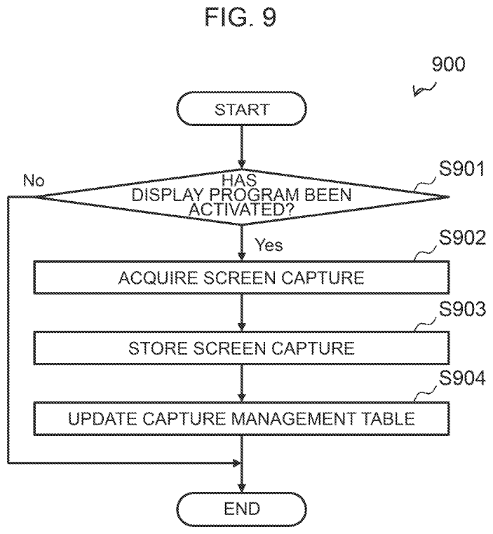

In the acquisition processing 810, the integration system 100 acquires, as a screen capture 812, an overall screen display 811 of the GUI product 102 according to each acquisition condition of the acquisition condition information 111, and stores (accumulates) the acquired screen capture 812. Note that the details of the acquisition processing 810 will be explained later with reference to FIG. 9.

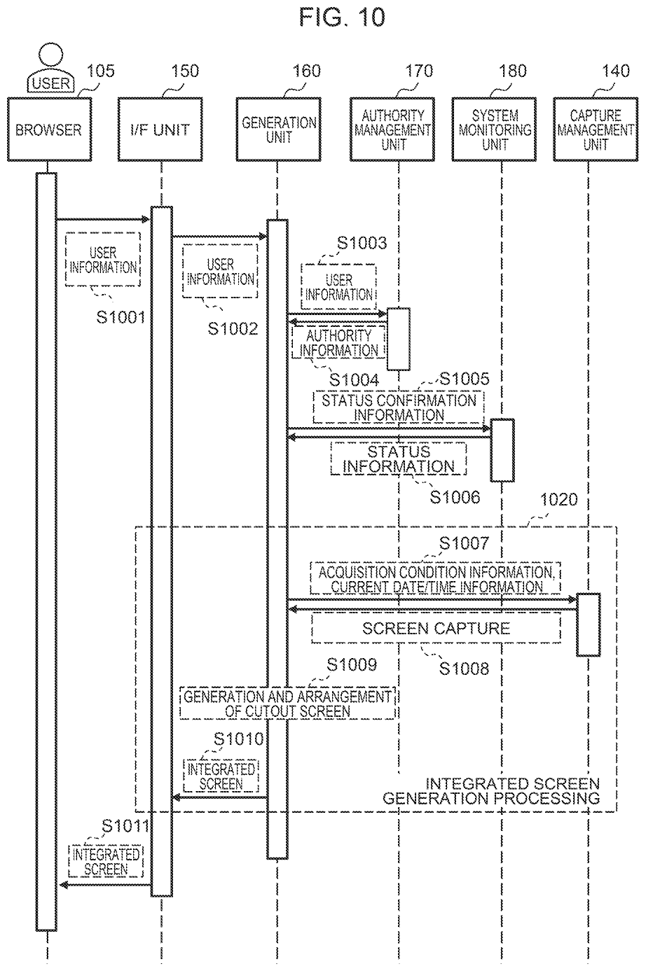

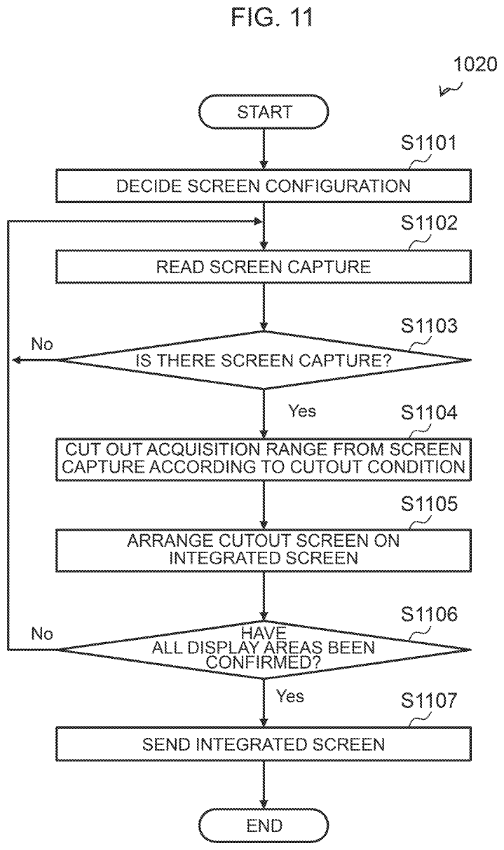

In the generation processing 820, the integration system 100 reads one or more screen captures 822 to be used in an integrated screen 821 based on the current date/time information indicating the current time/date and the capture management information 112 according to a browsing request of the integrated screen from the client terminal 103. The integration system 100 cuts out a screen of one or more areas 823 to be used in the integrated screen 821 from the screen capture 822 that was read according to the cutout condition of the cutout condition information 115. The integration system 100 arranges the screens of the areas 823 that were cut out (cutout screens) on a display area 824 of the integrated screen 821 according to the screen configuration of the screen configuration information 114. FIG. 8 shows an example where four screen captures 822 to be used in the integrated screen are read, and a screen cut out from one of those screen captures 822 has been arranged in a display area 824-1. Note that the details of the generation processing 820 will be explained later with reference to FIG. 10 and FIG. 11.

FIG. 9 is a diagram showing an example (screen capture acquisition processing 900) of the acquisition processing 810. The screen capture acquisition processing 900 is executed according to the acquisition frequency for each record (acquisition condition) of the acquisition condition table 300. In addition, a plurality of screen capture acquisition processing 900 may be executed at the same timing.

In step S901, the acquisition unit 130 determines whether a display program (process) identified by the display program ID 302 of the record to be processed has been activated. The acquisition unit 130 proceeds to the processing of step S902 when it determines that the display program has been activated, and the acquisition unit 130 ends the screen capture acquisition processing 900 when it determines that the display program has not been activated.

In step S902, the acquisition unit 130 acquires a screen capture of the screen display based on the display program, and assigns a capture ID to the acquired screen capture. The acquisition unit 130 sends the screen capture, to which the capture ID has been assigned, to the storage unit 110, and sends, to the capture management unit 140, the screen capture to which the capture ID has been assigned, the acquisition condition ID indicating the acquisition condition of the screen capture, and the acquisition date/time.

In step S903, the storage unit 110 stores the screen captures acquired by the acquisition unit 130 in the auxiliary storage device 203.

In step S904, the capture management unit 140 updates the capture management table 400, and ends the screen capture acquisition processing 900. More specifically, the capture management unit 140 adds, to the capture management table 400, a record which associates the capture ID of the screen capture acquired by the acquisition unit 130, the acquisition condition ID, and the acquisition date/time.

According to the foregoing processing, a screen capture according to the acquisition frequency is acquired for each acquisition condition.

FIG. 10 is a diagram showing an example of the series of processing (sequence) in the generation processing 820.

In step S1001, the browser 105 sends, to the I/F unit 150, a browsing request including the user information of the user according to the operation of that user to browse the integrated screen. In this example, a case where the user information includes the user's login user ID “user A” is explained.

In step S1002, when the I/F unit 150 receives a browsing request, the I/F unit 150 sends the user information including the browsing request to the generation unit 160. Note that the browsing request may include the current date/time information which indicates the current date/time. In the foregoing case, the I/F unit 150 sends the current date/time information to the generation unit 160.

In step S1003, when the generation unit 160 receives the user information, the generation unit 160 sends the user information to the authority management unit 170 in order to confirm the user's authority.

In step S1004, the authority management unit 170 refers to the authority table 500, identifies the authority information corresponding to the user information, and sends the identified authority information to the generation unit 160. In this example, the authority management unit 170 identifies a record of the first row which coincides with “user A” in which the value of the login user ID 501 is included in the user information, acquires the authority 502 “administrator” of the identified record of the first row, and sends the acquired authority 502 “administrator” to the generation unit 160.

In step S1005, the generation unit 160 sends the status confirmation information to the system management unit 180 in order to confirm the status of the system to be monitored.

In step S1006, when the system management unit 180 receives the status confirmation information, the system management unit 180 acquires the current status information of the system to be monitored from the system monitoring application 104, and sends the acquired status information to the generation unit 160. In this example, let it be assumed that “normal” has been acquired as the status information.

In step S1007, the generation unit 160 identifies the acquisition condition information indicating the acquisition condition of acquiring the screen capture to be used in generating the integrated screen, and sends the identified acquisition condition information and the current date/time information, which indicates the current date/time, to the capture management unit 140. Note that, when the generation unit 160 identifies a plurality of pieces of acquisition condition information, the acquisition condition information and the current date/time information are sent for each piece of acquisition condition information (for each screen capture). Note that the processing (integrated screen generation processing 1020) of step S1007 to step S1010 will be explained later with reference to FIG. 11.

In this example, foremost, the generation unit 160 refers to the screen configuration table 600, and identifies a record (screen configuration) of the first row in which the value of the user/authority 602 coincides with the received authority information “administrator” and the value of the status 603 coincides with the received status information “normal”. Next, the generation unit 160 acquires the value “acquisition condition 1, acquisition condition 2, acquisition condition 3” of the display area 604 included in the identified record. Next, the generation unit 160 identifies first acquisition condition information indicating “acquisition condition 1”, second acquisition condition information indicating “acquisition condition 2”, and third acquisition condition information indicating “acquisition condition 3” which were acquired.

In step S1008, when the capture management unit 140 receives the acquisition condition information and the current date/time information, the capture management unit 140 reads the screen capture corresponding to the acquisition condition information and the current date/time information, and sends the read screen capture to the generation unit 160. In the following explanation, let it be assumed that the current date/time information was “2020/11/110:00:01”.

In this example, foremost, the capture management unit 140 identifies a record of the fourth row in which the value of the acquisition condition ID 402 is “acquisition condition 1” and the latest date/time is “2020/11/110:00:01”. Next, the capture management unit 140 reads the screen capture in which the value of the capture ID 401 of the record of the fourth row is “capture file 4” from the auxiliary storage device 203 via the storage unit 110, and sends the read screen capture to the generation unit 160. Note that the same processing is also performed for “acquisition condition 2” and “acquisition condition 3”.

In step S1009, when the generation unit 160 receives the screen captures, the generation unit 160 generates an integrated screen. In this example, the generation unit 160 refers to the cutout condition table 700, and identifies a record of the second row in which the value of the acquisition condition ID 702 is “acquisition condition 1” and the current date/time satisfies the application start date/time 704 and the application end date/time 705. Next, the generation unit 160 cuts out a screen from the screen capture of “capture file 4” according to the acquisition range 703 of the identified record. Next, the generation unit 160 arranges the cut-out screen in “display area 1” in which the value of the display area 604 corresponds to “acquisition condition 1” according to the screen configuration (record of the first row of the screen configuration table 600) identified in step S1007. Note that the same processing is also performed for “acquisition condition 2” and “acquisition condition 3”.

In step S1010, the generation unit 160 sends the generated integrated screen to the I/F unit 150.

In step S1011, when the I/F unit 150 receives the integrated screen, the I/F unit 150 sends the received integrated screen to the browser 105.

FIG. 11 is a diagram showing an example of the integrated screen generation processing 1020.

In step S1101, the generation unit 160 decides the screen configuration of the integrated screen. More specifically, the generation unit 160 refers to the screen configuration table 600, and identifies a record (screen configuration information) corresponding to the user information or the authority information, and the status information. For example, the generation unit 160 generates the acquisition condition information for acquiring a screen capture to become the source of the cutout screen to be displayed in each display area of the integrated screen as described above.

In step S1102, the generation unit 160 reads the screen capture. More specifically, the generation unit 160 reads the screen capture corresponding to one piece of unprocessed acquisition condition information among the acquisition condition information generated in step S1101, and the current date/time information, via the capture management unit 140. Note that the capture management unit 140 refers to the capture management table 400, and reads the latest screen capture among the screen captures in which the value of the acquisition condition ID 402 coincides with the acquisition condition ID of the acquisition condition information, and sends the latest screen capture to the generation unit 160.

In step S1103, the generation unit 160 determines whether it was possible to read the screen capture. The generation unit 160 proceeds to the processing of step S1104 when it determines that it was possible to read the screen capture, and proceeds to the processing of step S1102 when it determines that it was not possible to read the screen capture. In addition, there are cases where the screen capture has not been acquired when the acquisition frequency is great (for example, when the acquisition frequency is one year) and, in the foregoing case, the generation unit 160 is unable to read the screen capture.

In step S1104, the generation unit 160 cuts out a screen of the acquisition range from the read screen capture according to the cutout condition. The generation unit 160 refers to the cutout condition table 700, and identifies a record in which the value of the acquisition condition ID 702 of the record identified in step S1101 and the acquisition condition ID of the acquisition condition information used for reading the screen capture in step S1102 coincide and in which the current date/time information satisfies the application start date/time 704 and the application end date/time 705. Subsequently, the generation unit 160 cuts out a screen of the area of the acquisition range 703 of the identified record from the screen capture read in step S1102.

In step S1105, the generation unit 160 arranges the cut-out image on the integrated screen. For example, the generation unit 160 identifies a display area in which the value of the display area 604 and the acquisition condition ID indicating the acquisition condition of the screen capture read in step S1102 coincide, and arranges the screen that was cut out from the screen capture (cutout screen) on the identified display area.

In step S1106, the generation unit 160 determines whether the processing has been performed to all display areas of the integrated screen decided in step S1101. The generation unit 160 proceeds to the processing of step S1107 when it determines that the processing has been performed to all display areas of the integrated screen, and proceeds to the processing of step S1102 when it determines that the processing has not been performed to one or more display areas of the integrated screen.

In step S1107, the generation unit 160 sends the integrated screen to the I/F unit 150.

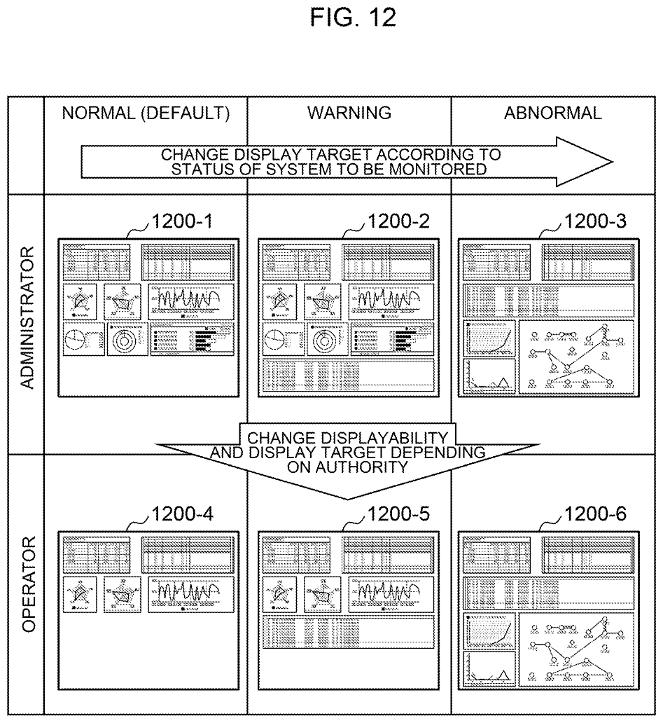

FIG. 12 is a diagram showing an example (integrated screen 1200) of the integrated screen. As shown in FIG. 12, the contents displayed on the integrated screen 1200 are changed according to the authority and the status. Note that, while not shown, the contents displayed on the integrated screen 1200 are changed according to the user and the status.

For example, when the user's authority is “administrator”, the status of the system to be monitored being “normal” means that an integrated screen 1200-1 is displayed on the browser 105, and the status of the system to be monitored being a “warning” means that an integrated screen 1200-2 is displayed on the browser 105, and the status of the system to be monitored being “abnormal” means that an integrated screen 1200-3 is displayed on the browser 105.

Moreover, for example, when the user's authority is “operator”, the status of the system to be monitored being “normal” means that an integrated screen 1200-4 is displayed on the browser 105, the status of the system to be monitored being a “warning” means that an integrated screen 1200-5 is displayed on the browser 105, and the status of the system to be monitored being “abnormal” means that an integrated screen 1200-6 is displayed on the browser 105.

In this embodiment, the screen configuration information is decided from the login user's authority information or user information and the current status information of the system to be monitored, the latest screen capture corresponding to the acquisition condition defined in the decided screen configuration information is acquired, and the acquired screen capture is used to generate and display an integrated screen. According to the foregoing configuration, the GUI products 102 can be integrated without having to modify the GUI products 102.

Note that, while this embodiment explained a case in which the GUI integration server 101 acquires a screen capture of the overall screen display, the present invention is not limited thereto. For example, the GUI integration server 101 may also acquire a screen capture of a part of the screen display (screen to be used in the integrated screen).

### (II) Second Embodiment

This embodiment mainly differs from the first embodiment with respect to the point that the past integrated screen can be browsed. In this embodiment, the same configuration as the first embodiment will be given the same reference numeral and the explanation thereof will be omitted.

Conventionally, when an event such as an abnormality or failure (hereinafter referred to as the “defect”) occurs in the system to be monitored, the user may wish to browse past information in the GUI product that is monitoring the item to be monitored containing the defect. Here, since the user is required to operate the GUI product and acquire the past information, much time is required for assessing the defect that occurred in the system to be monitored.

With respect to this point, the integration system comprises a user interface capable of designating a past time. Consequently, since the screen capture of the time designated by the user interface is acquired and an integrated screen is displayed, the user can obtain the past information without having to operate the GUI products.

Note that, with the configuration described above, since an integrated screen is generated using a previously stored screen capture of the GUI product, when the screen layout of the GUI product is changed, proper information cannot be acquired unless the condition information indicating the acquisition range is changed. Moreover, with the configuration of acquiring the screen capture of the acquisition range of the screen display (part of the screen display), when the screen layout of the GUI product is changed, changes cannot be made by going back to the past information. With respect to this point, the integration system of this embodiment manages the condition information according to the fact that the screen layout of the GUI product has been changed. Moreover, the integration system of this embodiment acquires the overall screen display without limiting the acquisition range upon acquiring the screen capture. Subsequently the integration system of this embodiment generates an integrated screen by acquiring the acquisition range part from the entire screen capture based on the condition information applicable to a predetermined time when generating an integrated screen of a predetermined time. Since what is stored in the integration system of this embodiment is the screen capture of the overall screen display, even when the acquisition range is subsequently changed, required information can be acquired. Note that, when the screen layout of the GUI product will never be changed, the integration system of this embodiment may also be configured to acquire the screen capture of the overall screen display.

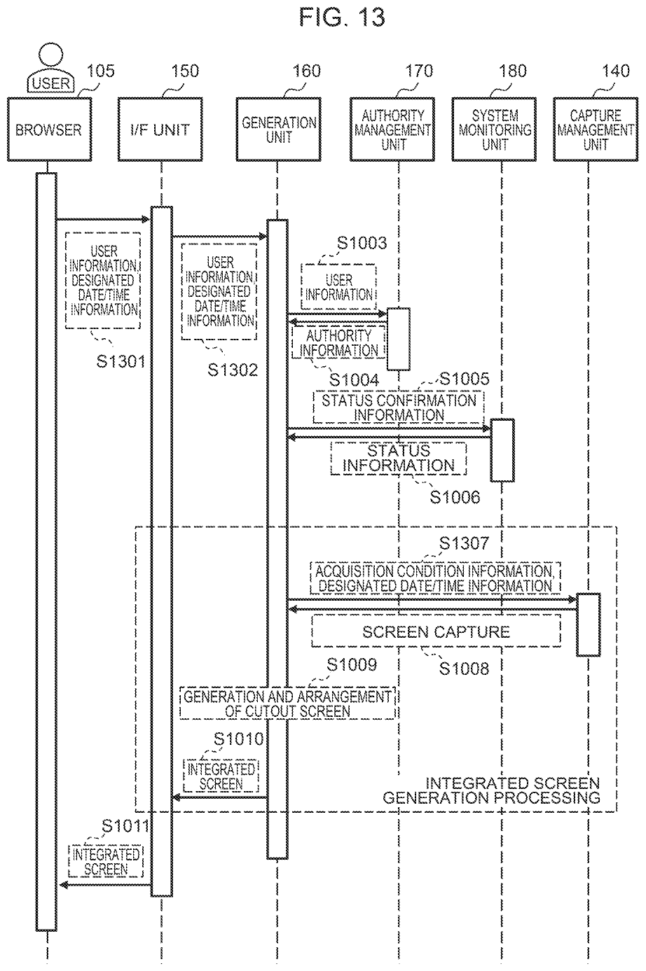

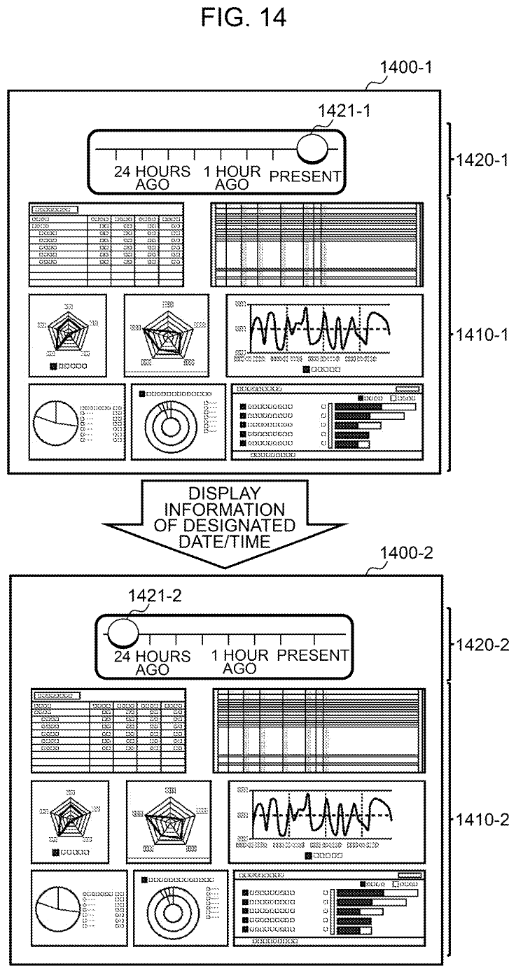

This embodiment is now explained with reference to FIG. 13 and FIG. 14.

FIG. 13 is a diagram showing an example of the sequence in this embodiment.

In step S1301, the browser 105 sends, to the I/F unit 150, a browsing request including the user information and the designated date/time information indicating the date/time that was designated according to the user's operation of designating a past date/time.

In step S1302, when the I/F unit 150 receives the browsing request, the I/F unit 150 sends the user information and the designated time information included in the browsing request to the generation unit 160.

In step S1307, the generation unit 160 sends the acquisition condition information and the designated date/time information to the capture management unit 140. Note that, while the capture management unit 140 read the screen capture using the current date/time information in the first embodiment, the capture management unit 140 reads the screen capture using the designated date/time information in this embodiment. For example, the capture management unit 140 refers to the capture management table 400, reads, among the screen captures in which the value of the acquisition condition ID 402 coincides with the acquisition condition ID of the acquisition condition information, a screen capture which is older than the designated date/time information and which is of a date/time that is closest to the designated date/time information, and sends the read screen capture to the generation unit 160.

FIG. 14 is a diagram showing an example (integrated screen 1400) of the integrated screen. FIG. 14 shows an example where a current integrated screen 1400-1 is switched to a past integrated screen 1400-2.

The integrated screen 1400 is provided with a display area 1410, and a date/time designation area 1420. The display area 1410 is an area for displaying a cutout screen of the GUI product 102. The date/time designation area 1420 is an area which includes a user interface 1421 capable of designating a past date/time. The user interface 1421 is a user interface used by the user for designating a past date/time. The user interface 1421 is a slide bar, a text box or the like.

For example, when the user performs an operation of designating a past date/time via the user interface 1421 on the current integrated screen 1400-1, the designated date/time is displayed on the integrated screen 1400-2. Consequently, the user can collectively confirm the information of the designated date/time. In other words, the trouble of operating each GUI product 102 and displaying past information can be avoided. Moreover, with the configuration described above, since the screen capture of each GUI product 102 is stored, the integrated screen 1400 can be displayed even when each GUI product 102 has already deleted past data.

### (III) Third Embodiment

This embodiment mainly differs from the first embodiment with respect to the point that the integrated screens can be compared. In this embodiment, the same configuration as the first embodiment will be given the same reference numeral and the explanation thereof will be omitted.

Conventionally, when a defect occurs in the system to be monitored, the user may wish to compare the integrated screen at the time that the defect occurred and the integrated screen at the time that the same defect occurred in the past. Here, since the user is required to identify the same defect that occurred in the past, and operate all GUI products of the date/time that the same defect occurred and acquire the past information, much time is required for browsing the same defect that occurred in the past, and much time is required for assessing the defect that occurred in the system to be monitored.

With respect to this point, when a defect occurs in the system to be monitored, the integration system of this embodiment associates the information indicating the defect (“DB error”, “network error”, “server outage” or the like) and the time that the defect occurred, and stores this as monitoring information. Moreover, the integration system of this embodiment comprises a user interface for selecting a defect that is the same as the defect that occurred in the system to be monitored. When the user interface is operated, the integration system identifies the time that a defect that is the same as the defect that occurred in the system to be monitored had occurred, and acquires a screen capture of each GUI product required for generating an integrated screen of the identified time. Consequently, since an integrated screen at the time that the same defect occurred in the past is displayed, for example, the user is not required to operate the GUI products for displaying an integrated screen at the time that the same defect occurred in the past, and can compare the integrated screen at the time that the defect occurred in the system to be monitored and the integrated screen at the time that the same defect occurred in the past.

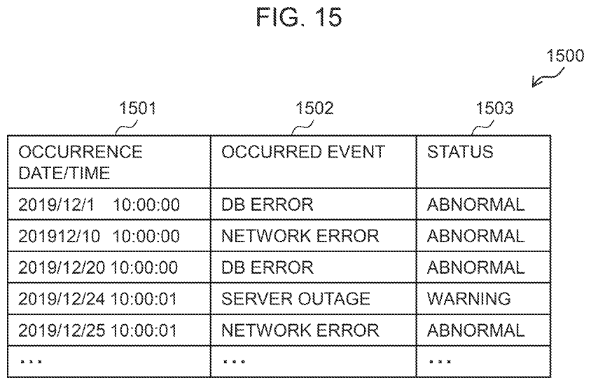

This embodiment is now explained with reference to FIG. 15 to FIG. 17.

FIG. 15 is a diagram showing an example (monitoring table 1500) of the monitoring information.

The system monitoring application 104 of this embodiment manages the event information indicating an event that occurred in the system to be monitored. The event information includes information of the time that a defect such as a warning or an abnormality occurred in the system to be monitored, details of the defect, and status of the system to be monitored. The system management unit 180 of this embodiment acquires the event information from the system monitoring application 104, and stores, as monitoring information, information including a part or all of the acquired event information in the auxiliary storage device 203 via the storage unit 110.

The monitoring table 1500 stores a record including values of a plurality of items indicating the monitoring information. More specifically, the monitoring table 1500 stores a record associated with information such as an occurrence date/time 1501, an occurred event 1502, and a status 1503.

The occurrence date/time 1501 is an item indicating the information of the date/time that the defect occurred in the system to be monitored. The occurred event 1502 is an item indicating the information of the details of the defect. The status 1503 is an item indicating the status information of the system to be monitored at the time that the defect occurred in the system to be monitored.

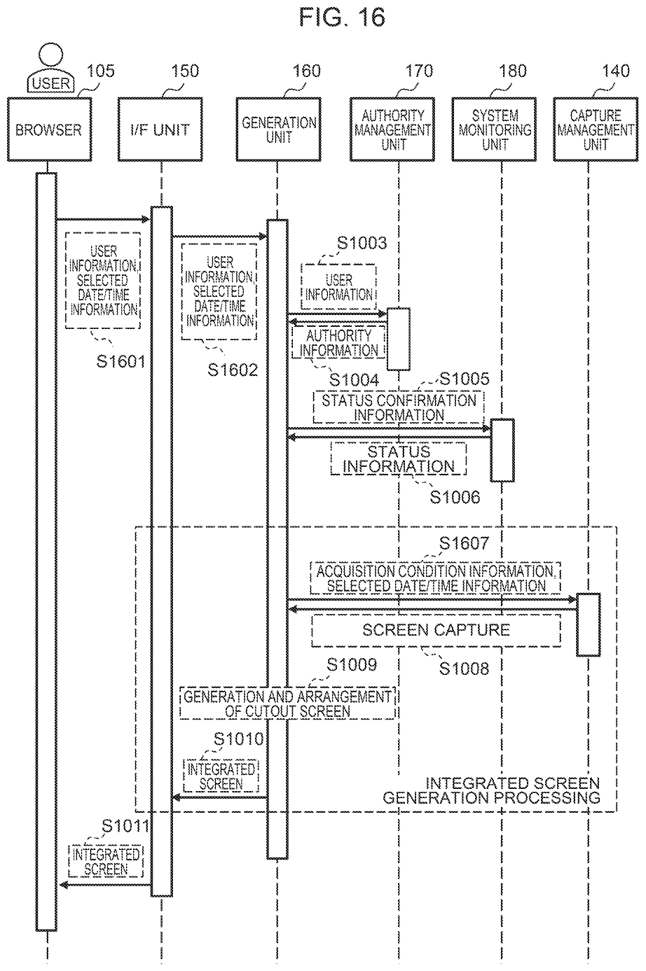

FIG. 16 is a diagram showing an example of the sequence in this embodiment.

In step S1601, the browser 105 sends, to the I/F unit 150, a browsing request including the user information and the selected date/time information indicating the selected date/time according to the user's operation of selecting the date/time that the same defect occurred.

In step S1602, when the I/F unit 150 receives the browsing request, the I/F unit 150 sends the user information and the selected date/time information included in the browsing request to the generation unit 160.

In step S1607, the generation unit 160 sends the acquisition condition information and the selected date/time information to the capture management unit 140. Note that, while the capture management unit 140 read the screen capture using the current date/time information in the first embodiment, the capture management unit 140 reads the screen capture using the selected date/time information in this embodiment. For example, the capture management unit 140 refers to the capture management table 400, reads, among the screen captures in which the value of the acquisition condition ID 402 coincides with the acquisition condition ID of the acquisition condition information, a screen capture which is older than the selected date/time information and which is of a date/time that is closest to the selected date/time information, and sends the read screen capture to the generation unit 160.

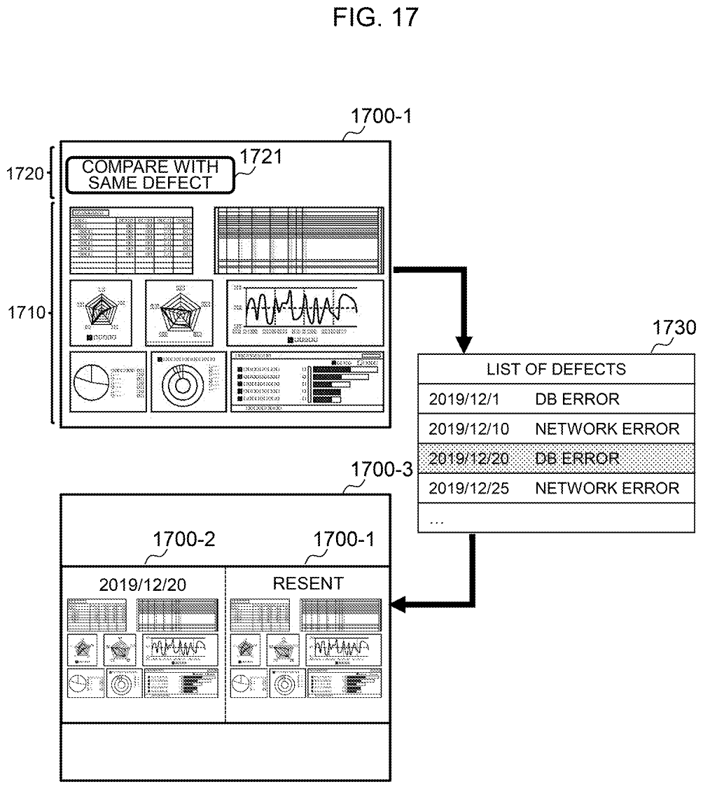

FIG. 17 is a diagram showing an example (integrated screen 1700) of the integrated screen. FIG. 17 shows an example where an integrated screen 1700-1 at the time that a defect occurred in the system to be monitored is switched to an integrated screen 1700-3 including an integrated screen 1700-1 and an integrated screen 1700-2 at the time that a defect that is the same as the defect that occurred in the system to be monitored.

The integrated screen 1700-1 is provided with a display area 1710, and a date/time selection area 1720. The display area 1710 is an area for displaying a cutout screen of the GUI product 102. The date/time selection area 1720 is an area which includes a user interface 1721 for displaying a selection screen 1730 capable of selecting a defect that is the same as the defect that occurred in the system to be monitored. The user interface 1721 is a text box, a button or the like. The date/time selection area 1720 is provided to an integrated screen 1700-1 when a defect occurs in the system to be monitored. For example, the user interface 1721 is displayed on the integrated screen 1700-1 when a defect occurs in the system to be monitored. When the user operates the user interface 1721, the selection screen 1730 for selecting a defect that is the same as the defect that occurred in the past is displayed.

In this embodiment, the generation unit 160 refers to the monitoring table 1500, identifies a record of a status that coincides with the status of the system to be monitored at the time that a defect occurred, generates the selection screen 1730 which includes, as a list, a value of the occurrence date/time 1501 and a value of the occurred event 1502 of the identified record, and sends the generated selection screen 1730 to the browser 105.

When the user performs an operation for selecting the date/time that the same defect occurred on the selection screen 1730, an integrated screen 1700-2 of the selected date/time is displayed next to an integrated screen 1700-1 (display area 1710) on an integrated screen 1700-3. Consequently, the user can confirm the information of the date/time selected from a list of defects that occurred in the system to be monitored and the information of the current date/time by arranging them next to each other. Moreover, the trouble of displaying the past information with each GUI product 102 can be avoided. Moreover, with the configuration described above, since the screen capture of each GUI product 102 is stored, the integrated screen 1700 can be displayed even when each GUI product 102 has already deleted past data. Moreover, comparison with the time that the defect occurred in the past can be facilitated, and the time required for the research can be shortened.

While this embodiment illustrated an example of arranging the integrated screen 1700-1 and the integrated screen 1700-2 adjacently in the horizontal direction, the mode of display is not limited thereto. The integrated screen 1700-1 and the integrated screen 1700-2 may also be arranged adjacently in the vertical direction, or the integrated screen 1700-1 and the integrated screen 1700-2 may be displayed in separate windows, or may be displayed in other modes.

### (IV) Supplementary Notes

The embodiments described above include, for example, the following subject matter.

While the foregoing embodiments explained a case of applying the present invention to an integration system, the present invention is not limited thereto, and may also be broadly applied to various other types of systems, devices, methods, and programs.

Moreover, while the foregoing embodiments explained a case where one screen is cut out from the screen capture, the present invention is not limited thereto. For example, a plurality of screens may also be cut out from the screen capture.

Moreover, while the foregoing embodiments explained a case where the GUI integration server 101 outputs an integrated screen according to a browsing request from the client terminal 103, the present invention is not limited thereto. For example, the GUI integration server 101 may also output an integrated screen to the client terminal 103 at a predetermined timing. Note that the predetermined timing may be constantly, regularly (periodically), at a predetermined time, timing designated by the user, or any other timing.

Moreover, while the foregoing embodiments explained a case of displaying the selection screen 1730 which enables the selection of a defect that is the same as the defect that occurred in the system to be monitored, the present invention is not limited thereto. For example, a selection screen which enables the selection of an event that is the same as a predetermined event that occurred in the system to be monitored. In other words, a predetermined event is not limited to a warning, or a defect such as an abnormality. A predetermined event may also be a caution or normality, and is at least one event such as normality, caution, warning, abnormality or the like.

Moreover, in the foregoing embodiments, the configuration of each table is merely an example, and one table may be divided into two or more tables or all or a part of two or more tables may be one table.

Moreover, in the foregoing embodiments, the illustrated and explained screens are merely an example, and may be of any design so as long as the received information is the same.

Moreover, in the foregoing embodiments, the illustrated and explained screens are merely an example, and may be of any design so as long as the presented information is the same.

Moreover, in the foregoing embodiments, the output of information is not limited to a visual output on a display. The output of information may also be a sound output from a speaker, output to a file, printing on a paper medium or the like by a printing device, projecting on a screen or the like by a projector, or any other mode of output.

Moreover, in the foregoing explanation, information such as programs, tables, files and the like which realize the respective functions may also be stored in a memory, a storage device such as a hard disk or an SSD (Solid State Drive), or a storage medium such as an IC card, an SD card, a DVD or the like.

The embodiments described above include, for example, the following characteristic configurations.

(1)

An integration system (for example, integration system 100) to which are connected a plurality of GUI (Graphical User Interface) products (for example, GUI products 102) as application programs comprising a GUI, comprising: an acquisition unit (for example, acquisition unit 130, circuit, GUI integration server 101) which acquires a screen capture of each of the plurality of GUI products according to condition information (for example, acquisition condition information 111, cutout condition information 115) indicating a condition of acquiring the screen capture of the GUI product for each of the plurality of GUI products; a storage unit (for example, storage unit 110, circuit, GUI integration server 101) which stores the screen captures acquired by the acquisition unit; a generation unit (for example, generation unit 160, circuit, GUI integration server 101) which generates an integrated screen on which are arranged the screen captures stored in the storage unit according to the screen configuration information (for example, screen configuration information 114) indicating a screen configuration of the integrated screen regarding the plurality of GUI products; and an output unit (for example, I/F unit 150, circuit, GUI integration server 101) which outputs the integrated screen generated by the generation unit.

Note that the screen capture to be acquired by the acquisition unit may be a screen capture of the overall screen display, or a screen capture of a screen from the screen display of an area to be used in the integrated screen.

In the configuration described above, screen captures of the respective GUI products are acquired and output as an integrated screen. With the foregoing configuration, since a screen capture that can be acquired with the GUI equipped in the GUI product is used for the generation of the integrated screen, a plurality of GUI products can be integrated irrespective of whether the GUI product is equipped with an interface other than a GUI. For example, even if the GUI product to be integrated is does not have an interface other than a GUI product, there is no need to modify the GUI product, and the number of manhours for development required for such modification can be reduced.

(2)

The screen configuration information is provided for each piece of user information of a user using the integration system (for example, see FIG. 6). When the generation unit receives, from a client terminal (for example, client terminal 103), the user information of the user requesting to browse the integrated screen, the generation unit generates the integrated screen on which are arranged the screen captures stored in the storage unit according to the screen configuration information corresponding to the received user information (for example, see FIG. 10).

With the configuration described above, since the screen configuration information is provided for each piece of user information, the screen captures of the GUI products to be arranged on the integrated screen can be switched according to the user requesting to browse the integrated screen.

(3)

The integration system further comprises an authority management unit (for example, authority management unit 170, circuit, GUI integration server 101) which manages authority information (for example, authority information 113) indicating an authority of the user by associating the authority information with user information of the user using the integration system. The screen configuration information is provided for each piece of authority information indicating an authority of the user using the integration system(for example, see FIG. 6). When the generation unit receives, from a client terminal (for example, client terminal 103), the user information of the user requesting to browse the integrated screen, the generation unit acquires the authority information of the user via the authority management unit, and generates the integrated screen (integrated screen 1200-1, integrated screen 1200-4 or the like) on which are arranged the screen captures stored in the storage unit according to the screen configuration information corresponding to the acquired authority information (for example, see FIG. 10).

With the configuration described above, since the screen configuration information is provided for each piece of authority information of the user, the screen captures of the GUI products to be arranged on the integrated screen can be switched according to the authority of the user requesting to browse the integrated screen.

(4)

Each of the plurality of GUI products monitors items to be monitored of a predetermined system (for example, system to be monitored). The integration system further comprises a system management unit (for example, system management unit 180, circuit, GUI integration server 101) which manages status information indicating a status of the predetermined system. The screen configuration information is provided for each piece of status information indicating the status of the predetermined system (for example, see FIG. 6). The generation unit generates the integrated screen (integrated screen 1200-1, integrated screen 1200-2, integrated screen 1200-3 or the like) on which are arranged the screen captures stored in the storage unit according to the screen configuration information corresponding to the status information being managed by the system management unit (for example, see FIG. 10).

With the configuration described above, since the screen configuration information is provided for each piece of status information of the system including the items to be monitored by the GUI products, the screen captures of the GUI products to be arranged on the integrated screen can be switched according to the status of the system.

(5)

When the generation unit receives, from a client terminal (for example, client terminal 103), designated time information indicating a time designated in the client terminal, the generation unit generates the integrated screen (for example, integrated screen 1400-2) on which are arranged the screen captures corresponding to the received designated time information among the screen captures stored in the storage unit (for example, see FIG. 13).

With the configuration described above, for example, since an integrated screen on which are arranged the screen captures of a designated past time is output, the user can assess a past integrated screen without having to operate the GUI products.

(6)

Each of the plurality of GUI products monitors items to be monitored of a predetermined system (for example, system to be monitored). The integration system further comprises a system management unit (for example, system management unit 180, circuit, GUI integration server 101) which manages monitoring information (for example, monitoring table 1500) in which, when an event (for example, defect) which occurs in the predetermined system, contents of the event and a time that the event occurred are associated. In cases where an event occurs in the predetermined system, when monitoring information being managed by the system management unit is displayed on the client terminal (for example, client terminal 103) and the generation unit receives, from a client terminal, selection time information indicating a time that was selected as a time that a same event as the event occurred in the client terminal, the generation unit generates the integrated screen (integrated screen 1700-2, integrated screen 1700-3) on which are arranged the screen captures corresponding to the received selection time information among the screen captures stored in the storage unit (for example, see FIG. 16).

With the configuration described above, for example, in cases where an event occurs in the system including the items to be monitored by the GUI products, since an integrated screen on which are arranged screen captures of a time selected as a time that an event that is the same as the event occurred, the user can assess the integrated screen at the time that the same even occurred without having to operate the GUI products.

(7)

The condition information includes acquisition condition information (for example, acquisition condition information 111) indicating a frequency that the acquisition unit acquires a screen capture from each of the plurality of GUI products, and cutout condition information (for example, cutout condition information 115) indicating an area in which the screen to be used by the generation unit for generating the integrated screen is to be cut out from the screen capture acquired by the acquisition unit. The cutout condition information includes application time information (for example, values of application start date/time 704 and application end date/time 705) indicating a period that the cutout condition information is to be applied. The acquisition unit acquires a screen capture of the overall screen display for each of the plurality of GUI products according to the acquisition condition information. The storage unit stores the screen captures acquired by the acquisition unit. The generation unit identifies the cutout condition information including the application time information to which is applied the time information of the time for which browsing of the integrated screen was requested in the client terminal (for example, client terminal 103), cuts out screens to be used in generating the integrated screen from screen captures corresponding to the time information among the screen captures stored in the storage unit according to the identified cutout condition information, and generates the integrated screen on which are arranged the cutout screens according to the screen configuration information (for example, see FIG. 11).

According to the foregoing configuration, for example, an integrated screen can be generated even when a screen layout of the GUI product is changed.

Moreover, the foregoing configurations may be suitably changed, rearranged, combined or omitted to the extent that such change, rearrangement, combination or omission does not exceed the subject matter of the present invention.

Items included in a list according to a format of “at least one among A, B, and C” should be understood to mean (A), (B), (C), (A and B), (A and C), (B and C) or (A, B, and C). Similarly, items included in a list according to a format of “at least one among A, B, or C” should be understood to mean (A), (B), (C), (A and B), (A and C), (B and C) or (A, B, and C).

### REFERENCE SIGNS LIST

100 . . . integration system, 101 . . . GUI integration server, 102 . . . GUI product.

1. An integration system to which are connected a plurality of GUI (Graphical User Interface) products as application programs comprising a GUI, comprising:
an acquisition unit which acquires a screen capture of each of the plurality of GUI products according to condition information indicating a condition of acquiring the screen capture of the GUI product for each of the plurality of GUI products;
a storage unit which stores the screen captures acquired by the acquisition unit;
a generation unit which generates an integrated screen on which are arranged the screen captures stored in the storage unit according to the screen configuration information indicating a screen configuration of the integrated screen regarding the plurality of GUI products; and
an output unit which outputs the integrated screen generated by the generation unit.

2. The integration system according to claim 1, wherein:
the screen configuration information is provided for each piece of user information of a user using the integration system; and
when the generation unit receives, from a client terminal, the user information of the user requesting to browse the integrated screen, the generation unit generates the integrated screen on which are arranged the screen captures stored in the storage unit according to the screen configuration information corresponding to the received user information.

3. The integration system according to claim 1, further comprising:
an authority management unit which manages authority information indicating an authority of the user by associating the authority information with user information of the user using the integration system, wherein:
the screen configuration information is provided for each piece of authority information indicating an authority of the user using the integration system; and
when the generation unit receives, from a client terminal, the user information of the user requesting to browse the integrated screen, the generation unit acquires the authority information of the user via the authority management unit, and generates the integrated screen on which are arranged the screen captures stored in the storage unit according to the screen configuration information corresponding to the acquired authority information.

4. The integration system according to claim 1, wherein:
each of the plurality of GUI products monitors items to be monitored of a predetermined system;
the integration system further comprises a system management unit which manages status information indicating a status of the predetermined system;
the screen configuration information is provided for each piece of status information indicating the status of the predetermined system; and
the generation unit generates the integrated screen on which are arranged the screen captures stored in the storage unit according to the screen configuration information corresponding to the status information being managed by the system management unit.

5. The integration system according to claim 1, wherein:
when the generation unit receives, from a client terminal, designated time information indicating a time designated in the client terminal, the generation unit generates the integrated screen on which are arranged the screen captures corresponding to the received designated time information among the screen captures stored in the storage unit.

6. The integration system according to claim 1, wherein:
each of the plurality of GUI products monitors items to be monitored of a predetermined system;
the integration system further comprises a system management unit which manages monitoring information in which, when an event which occurs in the predetermined system, contents of the event and a time that the event occurred are associated; and
in cases where an event occurs in the predetermined system, when monitoring information being managed by the system management unit is displayed on the client terminal and the generation unit receives, from a client terminal, selection time information indicating a time that was selected as a time that a same event as the event occurred in the client terminal, the generation unit generates the integrated screen on which are arranged the screen captures corresponding to the received selection time information among the screen captures stored in the storage unit.

7. The integration system according to claim 1, wherein:
the condition information includes acquisition condition information indicating a frequency that the acquisition unit acquires a screen capture from each of the plurality of GUI products, and cutout condition information indicating an area in which the screen to be used by the generation unit for generating the integrated screen is to be cut out from the screen capture acquired by the acquisition unit;
the cutout condition information includes application time information indicating a period that the cutout condition information is to be applied;
the acquisition unit acquires a screen capture of the overall screen display for each of the plurality of GUI products according to the acquisition condition information;
the storage unit stores the screen captures acquired by the acquisition unit; and
the generation unit identifies the cutout condition information including the application time information to which is applied the time information of the time for which browsing of the integrated screen was requested in the client terminal, cuts out screens to be used in generating the integrated screen from screen captures corresponding to the time information among the screen captures stored in the storage unit according to the identified cutout condition information, and generates the integrated screen on which are arranged the cutout screens according to the screen configuration information.

8. An integration method in an integration system to which are connected a plurality of GUI (Graphical User Interface) products as application programs comprising a GUI, comprising:
a step of an acquisition unit acquiring a screen capture of each of the plurality of GUI products according to condition information indicating a condition of acquiring the screen capture of the GUI product for each of the plurality of GUI products;
a step of a storage unit storing the screen captures acquired by the acquisition unit;
a step of a generation unit generating an integrated screen on which are arranged the screen captures stored in the storage unit according to the screen configuration information indicating a screen configuration of the integrated screen regarding the plurality of GUI products; and
a step of an output unit outputting the integrated screen generated by the generation unit.
